(19) United States
(12) Patent Application Publication
(10) Pub. No.: US 2014/0338503 A1
(43) Pub. Date: Nov. 20, 2014

(54) Hand Tool Head Assembly and Housing Apparatus

(71) Applicant: Snap-on Incorporated, Kenosha, WI (US)

(72) Inventors: Joshua M. Beer, Racine, WI (US); Kenneth C. Happ, Burlington, WI (US)

(73) Assignee: Snap-on Incorporated, Kenosha, WI (US)

(21) Appl. No.: 13/894,805

(22) Filed: May 15, 2013

(51) Int. Cl. B25B 21/00; B25B 23/00

(52) U.S. Cl. CPC B25B 21/004; B25B 23/0007
USPC 81/57.39; 173/217; 29/525.01

(57) ABSTRACT

A hand tool, such as a motorized cordless ratchet wrench, is configured for reducing part count and reducing assembly processes. The hand tool includes a clamshell housing that may be fastened to a drive member such as a ratchet head assembly without the use of additional fasteners such as large clamp nuts or additional screw sets, for example. One or more protrusions extending inwardly from the clamshell housing engage similarly shaped voids in the ratchet head assembly. The protrusions tightly engage the ratchet head housing when the clamshell housing portions are fastened together.

### TECHNICAL FIELD OF THE INVENTION

The present invention relates to a motorized hand tool for applying torque to a work piece. More particularly, the present invention relates to a clamshell housing coupling to a head assembly of a motorized hand tool.

### BACKGROUND OF THE INVENTION

Power hand tools, such as motorized ratchet wrenches and drivers, are commonly used in automotive, industrial and household applications to install and remove threaded fasteners and to apply a torque and/or angular displacement to a work piece such as a threaded fastener, for example. Motorized hand tools, such as cordless power ratchets and drivers, generally include an electric motor contained in a clamshell housing along with other components such as switches, light emitting diodes (LEDs), and batteries, for example. The clamshell housing generally includes two or more housing portions fastened together by fasteners, such as screws or rivets.

The process of assembling a clamshell housing to a drive member, such as a ratchet head housing in a motorized hand tool, generally involves one or more large clamp nuts or a set of screws in addition to fasteners used to couple portions of the clamshell housing together, for example. The additional large clamp nuts and/or screws may create an unsightly appearance and may add bulk to portions of the tool, thereby impeding proper use of the tool in small spaces. The large clamp nuts may also loosen over time and allow the ratchet head to become loose from the clamshell housing.

### SUMMARY OF THE INVENTION

According to embodiments of the present invention, a motorized hand tool, such as a cordless ratchet wrench, includes a clamshell housing that may be fastened to a drive member such as a ratchet head assembly without the use of additional fasteners such as large clamp nuts or additional screw sets, for example. One or more protrusions extending inwardly from the clamshell housing engage similarly shaped voids in the ratchet head assembly. The protrusions may include a radial flange, a T-shaped protrusion and/or one or more screw bosses. The protrusions tightly engage the ratchet head housing when the clamshell housing portions are fastened together. The rigid connection created between the clamshell housing and the ratchet head housing absorbs torque and helps prevent the tool from breaking apart when subject to drops or other impacts.

According to aspects of the present invention, the cost of a motorized hand tool may be reduced by reduction of parts count and eliminating the manufacturing steps involved with installing clamp nuts or screws dedicated to fastening the ratchet head assembly to the clamshell housing. The disclosed hand tool is aesthetically improved and has fewer external fasteners that could loosen and/or interfere with comfortable use of the tool.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1A is a side view drawing illustrating an exemplar tool, such as a cordless ratchet tool including a ratchet head assembly coupled to a motor assembly, in accordance with an embodiment of the present invention.

FIG. 1B is a top view drawing illustrating an exemplar tool, such as a cordless ratchet tool including a ratchet head assembly coupled to a motor assembly, in accordance with an embodiment of the present invention.

FIG. 2 is an exploded view drawing of an exemplar tool having a ratchet head, motor and clamshell housing assembly of a cordless ratchet tool, in accordance with an embodiment of the present invention.

FIG. 3 is an exploded view drawing of an exemplar too having a ratchet head, motor, switch and clamshell housing assembly of a cordless ratchet tool, in accordance with an embodiment of the present invention.

FIG. 4A is an illustration of an exemplar too having a ratchet head and motor subassembly in accordance with an embodiment of the present invention.

FIG. 4B is an illustration of a ratchet head housing of a cordless ratchet tool in accordance with an embodiment of the present invention.

FIG. 4C is a cross sectional view of a ratchet head housing of a cordless ratchet tool in accordance with an embodiment of the present invention.

FIG. 4D is an illustration of a motor end plate of a cordless ratchet tool in accordance with an embodiment of the present invention.

FIG. 5 is an illustration of a clamshell housing portion in accordance with an embodiment of the present invention.

FIG. 6 is a process flow diagram illustrating a method of assembling a cordless ratchet tool in accordance with an embodiment of the present invention.

It should be understood that the comments included in the notes as well as the materials, dimensions and tolerances discussed therein are simply proposals such that one skilled in the art would be able to modify the proposals within the scope of the present invention.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present invention is to be considered as an exemplification of the principles of the invention and is not intended to limit the broad aspect of the invention to embodiments illustrated.

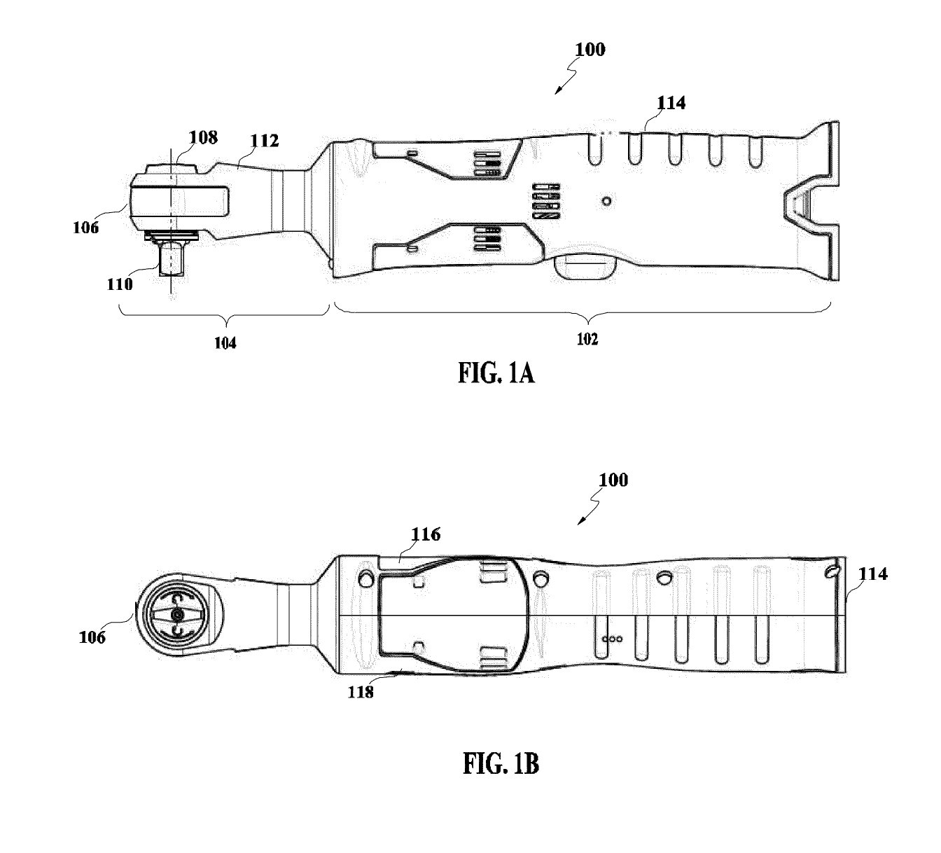

Embodiments of the present invention may be implemented in a hand tool, such as the cordless ratchet tool shown in FIG. 1A. The cordless ratchet tool 100 includes a handle portion 102 coupled to a driver portion 104. The driver portion 104 may include a ratchet head assembly 106 including a ratchet housing 112, ratchet head 110, and selector knob 108, for example. The handle portion 102 may include a main housing 114 enclosing an electric motor, a switch assembly and one or more status indicators such as light emitting diodes (LED), for example. FIG. 1B shows a top view of the cordless ratchet tool 100. Referring to FIG. 1B, the main housing 114 may be assembled from two or more clamshell housing portions 116, 118 fastened together and securely attached to the ratchet head assembly 106.

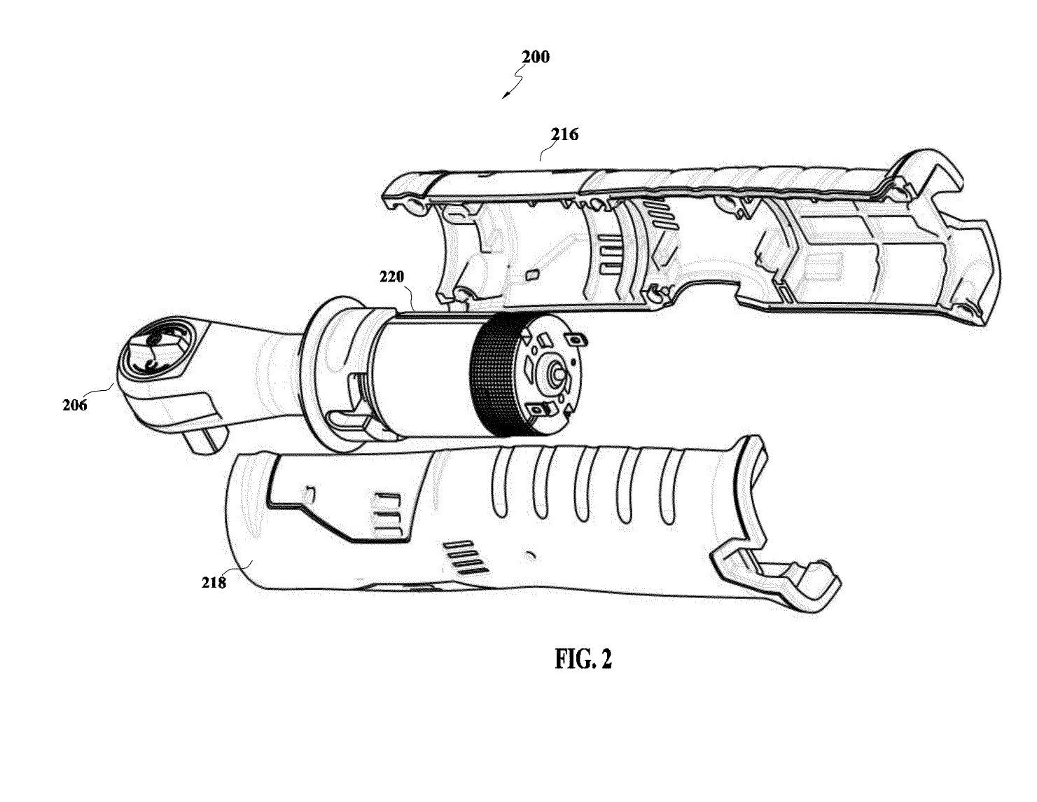

FIG. 2 shows a ratchet head assembly 206 of a cordless ratchet tool assembly 200 coupled to a motor assembly 220 according to an aspect of the present invention. A first clamshell housing portion 216 and second clamshell housing portion 218 of the cordless ratchet tool assembly 200 are configured for assembly around the motor assembly 220.

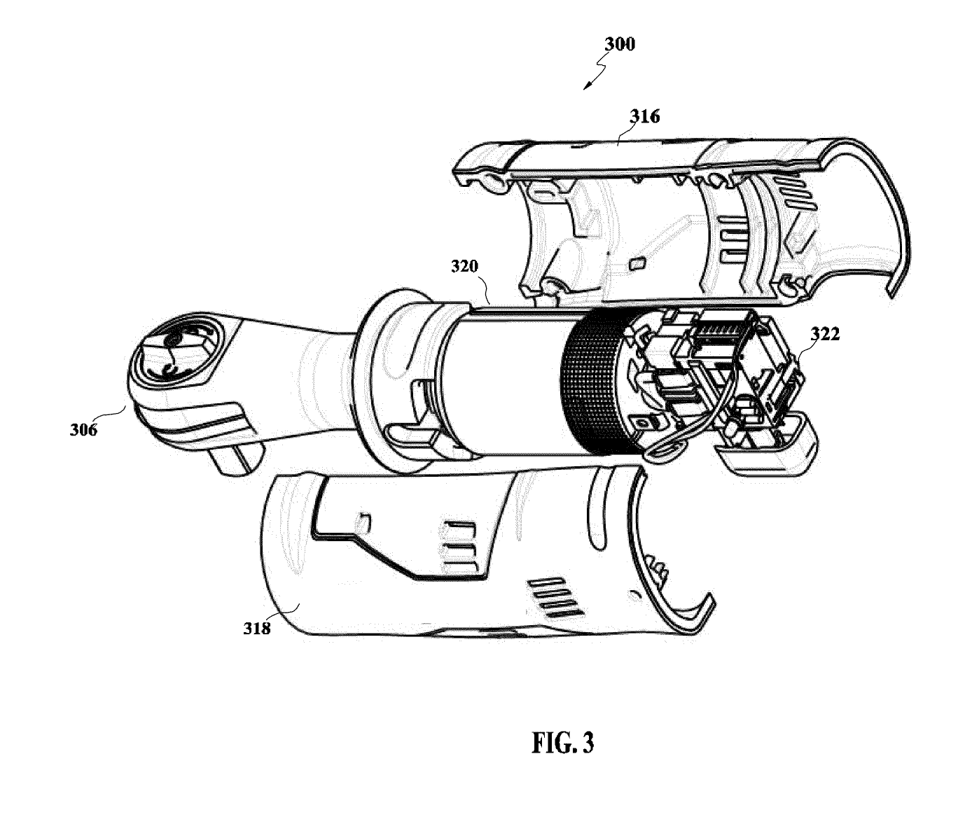

FIG. 3 shows a ratchet head assembly 306 of a cordless ratchet tool assembly 300 coupled to a motor assembly 320 and a switch assembly 322 according to another aspect of the present invention. A first clamshell housing portion 316 and second clamshell housing portion 318 of the cordless ratchet tool assembly 300 are configured for assembly around the motor assembly 320.

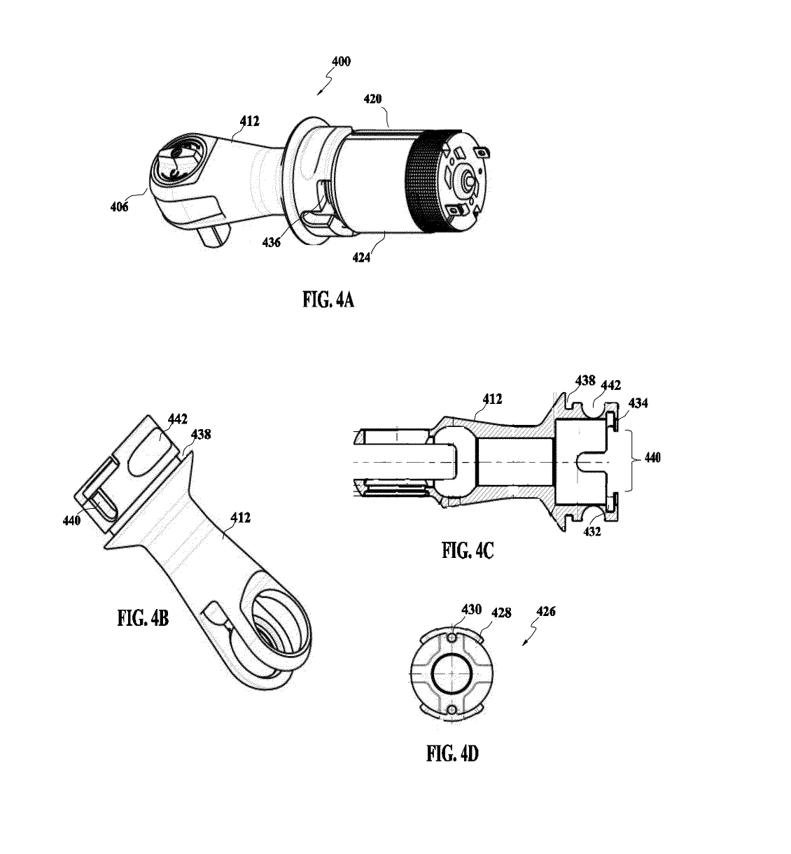

A ratchet head and motor subassembly 400 according to an aspect of the present invention is described with reference to FIGS. 4A-4D. The ratchet head and motor subassembly 400 shown in FIG. 4A includes a motor assembly 420 coupled to a ratchet head assembly 406. The motor assembly 420 includes an electric motor 420 coupled to a motor end plate such as the motor end plate 424 shown in FIG. 4D.

The motor end plate 426 may be fastened to the electric motor 424 by fasteners such as rivets or screws through fastener holes 430, for example. According to an aspect of the present invention, the motor end plate 426 includes one or more outwardly protruding semi-annular flanges 428. The flanges 428 are configured to fit in a semi-annular slot 432 formed by an undercut behind a lip 434 around a periphery in the ratchet head housing 412. One or more discontinuities in the lip 434 create one or more apertures 436 that are sized to cooperatively receive each of the one or more flanges 428 of the motor end plate 426 during assembly of the motor end plate 426 to the ratchet head housing 412 and during disassembly of the motor end plate 426 from the ratchet head housing 412. The motor end plate 426 may also include one or more detent structures (not shown) configured to provide tactile indications of proper rotation displacement during assembly.

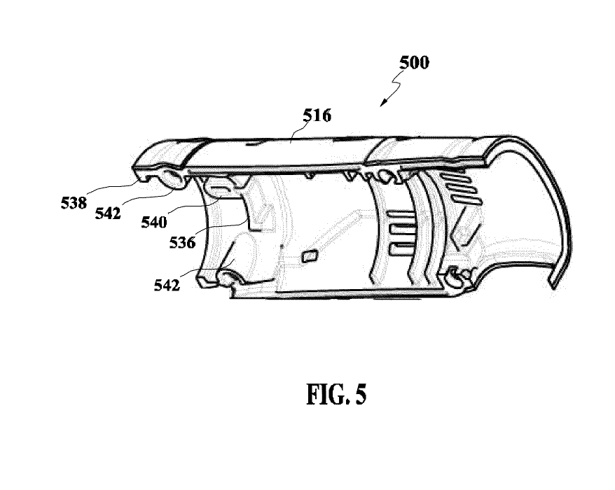

According to aspects of the present invention, the motor assembly 420 is coupled to the ratchet head housing 412 by pushing the flanges 428 of the motor end plate 426 through the apertures 436 in the lip 434 of the ratchet head housing 412 then rotating the motor assembly 420 relative to the ratchet head housing 412 until the flanges 428 of the motor end plate 426 are secured in the semi-annular slot 432 of the ratchet head housing 412. In one example, the flanges 428 and apertures 436 are sized so that the motor assembly 420 may be rotated 90 degrees in either direction to engage the semi-annular slots 432 of the ratchet head housing 412 during an assembly process or to disengage the semi-annular slots 432 of the ratchet head housing during a disassembly process. A compressible member such a steel wave washer or an O-ring (not shown) made from a compressible material such as rubber or other elastomer, for example, may be installed between the motor assembly 420 and the ratchet head housing 412 to absorb dimensional tolerances. The compressible member is compressed during assembly of the motor assembly 420 to the ratchet head housing 412 and provides pressure between the flange 428 and lip 434 that facilitates a tight fit and alignment of drive gears, for example. In an embodiment of the present invention, a rib protruding inwardly from one or more clamshell housing portions is shaped to substantially fill the one or more apertures 436 when the clam shell housing is assembled to the ratchet head and motor subassembly 400. Referring to FIG. 5, one or more semi-annular ribs 536 in a first clamshell housing portion 516 are shaped to fit into and substantially fill the one or more apertures 436, for example. The semi-annular ribs 536 prevent the motor end plate 426 from rotating out of the slot 432 in the ratchet head housing 412.

According to another embodiment of the present invention, one or more clamshell housing portions include one or more protrusions extending inwardly from the clamshell housing. The one or more protrusions tightly engage similarly shaped voids in the ratchet head assembly. Referring to FIG. 5, the protrusions may include a radial flange 538, a T-shaped protrusion 540 and/or one or more screw bosses 542. The protrusions tightly engage the ratchet head housing when the clamshell housing portions are fastened together. Referring to FIGS. 4A-4C, the ratchet head housing 412 may include a radial flange slot 438, a T-shaped aperture 440 and/or one or more concave channels 442 arranged to tightly receive the radial flange 538, the T-shaped protrusion 540 and/or the one or more screw bosses 542, respectively.

Referring to FIG. 2, a first clamshell housing portion 216 may be fastened to a second clamshell housing portion 218 around the ratchet head assembly 206 using fasteners such as screws or rivets, for example. When assembled, as shown in FIGS. 1A and 1B, for example, the inward protrusions on the clamshell housing prevent the ratchet head assembly from rotating or moving axially relative to the clamshell housing. The cordless ratchet tool 100 shown in FIGS. 1A and 1B may include the radial flange 538, a T-shaped protrusion 540 and/or one or more screw bosses 542 engaged with the radial flange slot 438. T-shaped aperture 440 and/or one or more concave channels 442 described above are intended to reduce parts count and eliminate the manufacturing steps that would otherwise be needed to installing clamp nuts or screws dedicated to fastening the ratchet head assembly to the clamshell housing. The disclosed cordless ratchet tool 100 may be constructed without externally projecting clamp nuts or screws that could loosen and/or interfere with comfortable use of the tool.

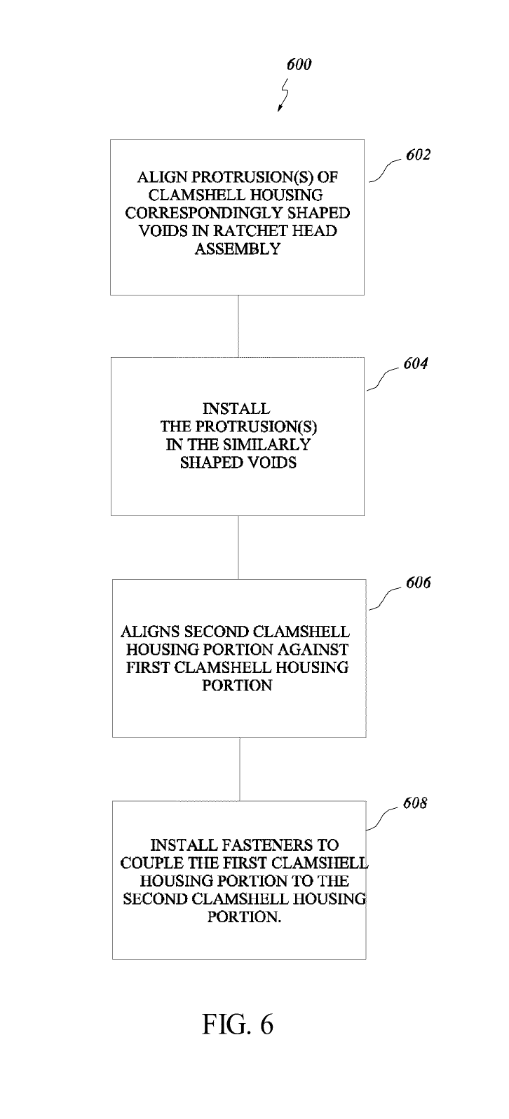

FIG. 6 is a process flow diagram illustrating a process 600 for assembling a hand tool according to an aspect of the present invention. As shown, the process 600 begins and proceeds to step 602, which includes aligning one or more protrusions of a first clamshell housing portion with one or more similarly shaped voids in a ratchet head assembly. In step 604, the process includes installing the one or more protrusions in the one or more similarly shaped voids. In step 606, the process includes aligning a second clamshell housing portion against the first clamshell housing portion. In step 608, the process includes installing fasteners to couple the first clamshell housing portion to the second clamshell housing portion. According to aspects of the present invention, the one or more protrusions may include a radial flange, a T-shaped protrusion and/or a screw boss extending inward from the first clamshell housing portion, for example.

As discussed above, the aspects of the present invention are described in terms of a cordless ratchet tool 100. as shown in FIG. 1. However, it should be understood that aspects of the present invention could be implanted in other hand tools or implements. For example, and without limitation, the hand tool can be ratchet wrench, open wrench, screw driver, nut driver, or any other tool capable of applying torque to a work piece.

As used herein, the term “coupled” or “communicably coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A motorized hand tool apparatus, comprising:
a head assembly coupled to the motor assembly; and
a clamshell housing assembled around the head assembly;
wherein the head assembly includes:
a head housing having one or more shaped apertures extending at least partially through a peripheral wall of the ratchet head housing;
wherein the clamshell housing includes:
an inwardly extending protrusion tightly engaged in the one or more shaped apertures and obstructing rotational and axial movement of the ratchet head housing relative to the clamshell housing.

2. The motorized hand tool apparatus of claim 1, wherein the inwardly extending protrusion includes a radial flange.

3. The motorized hand tool apparatus of claim 1, wherein the inwardly extending protrusion includes a T-shaped protrusion.

4. The motorized hand tool apparatus of claim 1, wherein the inwardly extending protrusion includes a fastener boss.

5. The motorized hand tool apparatus of claim 1, wherein the one or more shaped apertures include a radial slot configured to engage a radial flange of the clamshell housing.

6. The motorized hand tool apparatus of claim 1, wherein the one or more shaped apertures include a T-shaped aperture configured to engage in a T-shaped protrusion the clamshell housing.

7. The motorized hand tool apparatus of claim 1, wherein the one or more shaped apertures include a concave channel configured to engage a fastener boss of the clamshell housing.

8. The motorized hand tool of claim 7, further comprising a fastener engaged within the fastener boss, the fastener securely coupling the first clamshell housing to the second clamshell housing.

9. The motorized hand tool of claim 1, wherein the clamshell housing includes a first clamshell housing portion fastened to a second clamshell housing portion around the ratchet head assembly.

10. The motorized hand tool of claim 1, further comprising: a motor assembly coupled to the ratchet head assembly and enclosed within the clamshell housing and an electric motor coupled to the motor end plate.

11. A method of assembling a motorized hand tool apparatus, comprising:
aligning one or more protrusions of a first clamshell housing portion with one or more correspondingly shaped voids in a head assembly;
installing the one or more protrusions in the one or more correspondingly shaped voids;
aligning a second clamshell housing portion against the first clamshell housing portion; and
installing one or fasteners to couple the first clamshell housing portion to the second clamshell housing portion.

12. The method of claim 11, wherein the one or more protrusions include a radial flange, a T-shaped protrusion and a screw boss extending inward from the first clamshell housing portion.

13. The method of claim 11, further comprising coupling a motor assembly to the ratchet head assembly and enclosing the motor assembly within the clamshell housing.

14. A motorized cordless ratchet wrench, comprising:
a motor assembly;
a ratchet head assembly coupled to the motor assembly;
a steel wave washer compressed between the motor assembly and the ratchet head assembly; and
a clamshell housing assembled around the motor assembly and the ratchet head assembly;
wherein the ratchet head assembly includes:
a ratchet head housing having one or more shaped apertures extending at least partially through a peripheral wall of the ratchet head housing;
wherein the clamshell housing includes:
one or more inwardly extending protrusions tightly engaged in the one or more shaped apertures and obstructing rotation and axial movement of the ratchet head housing relative to the clamshell housing, the one or more inwardly extending protrusions include a radial flange, a T-shaped protrusion and a screw boss.
